(19) United States
(12) Patent Application Publication
(10) Pub. No.: US 2025/0330429 A1
(43) Pub. Date: Oct. 23, 2025

(54) APPARATUS, SYSTEM, AND METHOD FOR PACKET PROCESSING

(71) Applicant: Fujitsu Limited, Kawasaki-shi (JP)

(72) Inventor: Kazuto NISHIMURA, Yokohama (JP)

(73) Assignee: Fujitsu Limited, Kawasaki-shi (JP)

(21) Appl. No.: 19/253,277

(22) Filed: Jun. 27, 2025

Related U.S. Application Data
(63) Continuation of application No. PCT/JP2023/045639, filed on Dec. 20, 2023.

(30) Foreign Application Priority Data
Jan. 25, 2023 (JP) 2023-009497

(51) Int. Cl. H04L 47/625; H04L 47/34

(52) U.S. Cl. CPC H04L 47/625; H04L 47/34

(57) ABSTRACT

A controlling unit reads out, at timings that may be asynchronous to time slots, first counter values indicating quantities of arrived packets, collects second counter values read out at those timings along with corresponding readout times, and generates a data sequence where the second counter values are arranged; divides the data sequence into equal-length periods to obtain first and second periods, and superimposes first and second data sequences included in the first and second periods, respectively; and determines a first time range in which second counter values in the first data sequence are equal to or greater than one, and a second time range in which second counter values in the second data sequence are equal to or greater than one, identifies a common time range shared between the two time ranges, and estimates time slots corresponding to the common time range as packet arrival time slots.

### CROSS-REFERENCE TO RELATED APPLICATIONS

This application is a continuation application of International Application PCT/JP2023/045639 filed on Dec. 20, 2023, which designated the U.S., which is based upon and claims the benefit of priority of the prior Japanese Patent Application No. 2023-009497, filed on Jan. 25, 2023, the entire contents of which are incorporated herein by reference.

### FIELD

The embodiment discussed herein relates to a packet processing apparatus, a packet processing system, and a packet processing method.

### BACKGROUND

A packet network performs packet processing, such as route control, through a plurality of packet switches in order to transmit a packet to a predetermined destination. In some cases, a packet switch may perform packet transmission by controlling the transmission timing of the packet based on the time slot in which the packet has arrived.

As related technology, for example, a technique has been proposed in which, in accordance with the reception timing of each packet, the transmission of other packets having a lower priority than the packet is suspended for a predetermined period of time. Another proposed technique determines the time slots during which the transmission of low-priority packets is closed, based on a determination result of the cycle of high-priority packets. Furthermore, a technique has also been proposed in which a periodic pattern of received packets is identified based on the quantity of received packets per time slot, and, based on the identified periodic pattern, the opening and closing of a time slot interval for preferentially outputting the received packets is controlled.

Japanese Laid-open Patent Publication No. 2015-162719

Japanese Laid-open Patent Publication No. 2022- 019278

Japanese Laid-open Patent Publication No. 2018-125597

### SUMMARY

In one aspect, there is provided a packet processing apparatus including: a counter configured to count a quantity of packets that have arrived for each of a plurality of time slots to obtain respective first counter values; and a processor configured to: read out, at timings that may be asynchronous to the plurality of time slots, the first counter values to obtain respective second counter values, collect the second counter values read out at the timings and corresponding readout times, and generate a data sequence in which the collected second counter values are arranged in an order corresponding to the timings; divide the data sequence into a plurality of periods of equal length based on the readout times to obtain a first period and a second period, and superimpose, with respect to the first period and the second period, a first data sequence included in the first period and a second data sequence included in the second period; and determine, based on the readout times corresponding to the second counter values included in the first data sequence and the second data sequence, a first time range during which one or more of the second counter values included in the first data sequence are equal to or greater than one and a second time range during which one or more of the second counter values included in the second data sequence are equal to or greater than one, identify a common time range shared between the first time range and the second time range, and estimate time slots corresponding to the common time range as packet arrival time slots in which the packets have arrived.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a packet processing apparatus;

FIG. 2 illustrates an example of a communication network;

FIG. 3 illustrates an example of a configuration of a packet processing apparatus;

FIG. 4 illustrates an example of functional blocks of a packet processing unit;

FIG. 5 illustrates an example of a configuration of a packet processing system;

FIG. 6 illustrates an example of functional blocks of packet processing units included in a server apparatus and the packet processing apparatus;

FIG. 7 illustrates an example of a hardware configuration of the packet processing apparatus;

FIG. 8 illustrates a state where determination of packet arrival positions becomes uncertain;

FIG. 9 illustrates an example of a packet arrival position estimation process;

FIG. 10 is a flowchart illustrating an example of a data sequence generation process;

FIG. 11 illustrates an example of a flow of the data sequence generation process;

FIG. 12 is a flowchart illustrating an example of a packet arrival time detection process;

FIG. 13 is a flowchart illustrating the example of the packet arrival time detection process (continued from FIG. 12);

FIGS. 14A to 14C illustrate examples of counter value states during packet arrival time detection;

FIGS. 15A and 15B illustrate examples of counter value states during the packet arrival time detection;

FIG. 16 is a flowchart illustrating an example of a time window narrowing process performed during the packet arrival position estimation;

FIG. 17 illustrates an example of the time window narrowing process during the packet arrival position estimation;

FIG. 18 illustrates an example of a packet transmitting unit having a TAS function;

FIG. 19 illustrates an example of operation of a TAS;

FIG. 20 illustrates another example of the operation of the TAS;

FIG. 21 illustrates open and close states of output gates in relation to packet arrival positions; and

FIG. 22 illustrates an example of configuration states of a GCL.

### DESCRIPTION OF EMBODIMENTS

In a packet switch, for example, a time slot where packets have arrived (referred to as a packet arrival time slot) may be estimated by reading out a counter value, which counts the quantity of arrived packets for each time slot, in synchronization with the time slot.

However, due to processing contention between processes within the packet switch, the timing of the readout operation may become misaligned with the time slot, resulting in asynchronous readout. In conventional packet switches, when the counter value is read out at a timing that is asynchronous to the time slot, it becomes difficult to accurately estimate the packet arrival time slot.

Hereinafter, an embodiment will be described with reference to the drawings. It should be noted that, in the present specification drawings, and elements having substantially the same functions may be assigned the same reference numerals, and redundant descriptions thereof may be omitted.

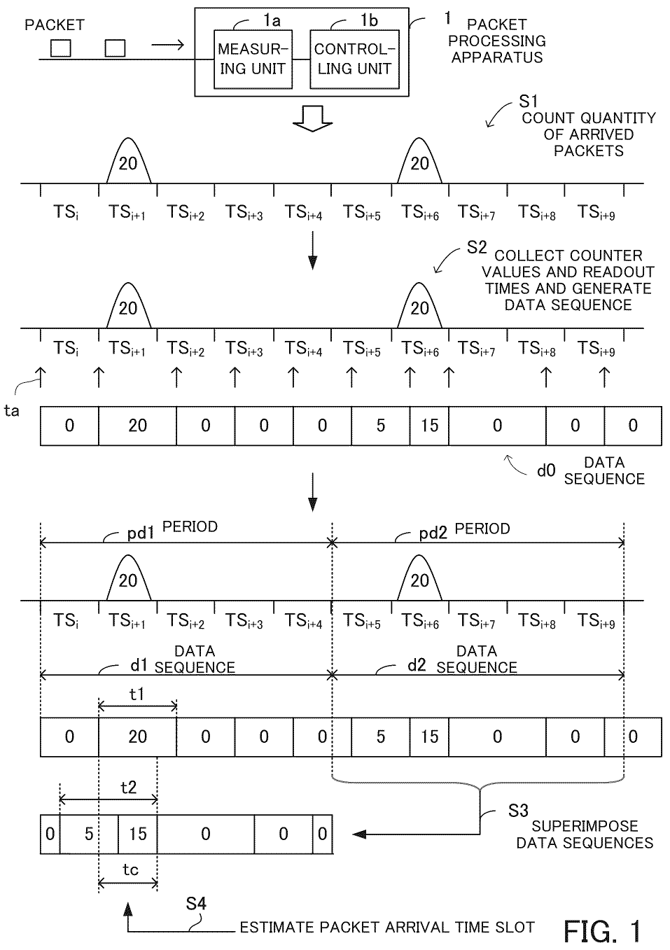

FIG. 1 illustrates an example of a packet processing apparatus. A packet processing apparatus 1 includes a measuring unit 1a and a controlling unit 1b.

Functions of the controlling unit 1b are implemented, for example, by a processor (not illustrated) included in the packet processing apparatus 1 executing a predetermined program.

[Step S1] The measuring unit 1a counts the quantity of arrived packets for each time slot TSᵢ, TSᵢ₊₁, and . . . to obtain a first counter value. In the example of FIG. 1, packets have arrived in the time slots TSᵢ₊₁ and TSᵢ₊₆, and the first counter values indicating the quantities of arrived packets in the time slots TSᵢ₊₁ and TSᵢ₊₆ are determined to be 20, while the first counter values for the other time slots are determined to be zero.

[Step S2] The controlling unit 1b reads out the first counter values at timings ta, which may be asynchronous with respect to the time slots TSᵢ, TSᵢ₊₁, and . . . . The controlling unit 1b also collects second counter values, which are the values of the first counter values read out at the timings ta, along with their respective readout times, and generates a data sequence do in which the collected second counter values are arranged in the order of being read out at the timings ta.

In the example of FIG. 1, the first counter values are read out at the timings ta, whereby second counter values of 0, 20, 0, 0, 0, 5, 15, 0, and . . . are obtained. Then, the data sequence do is generated by arranging the collected second counter values in the order read out at the timings ta.

[Step S3] The controlling unit 1b divides the data sequence do into a plurality of periods of equal length (i.e., equal cycle) based on the readout times. In the example of FIG. 1, the data sequence d0 is divided into equal-length periods pd1 and pd2. Then, for the divided periods pd1 and pd2, the controlling unit 1b superimposes a data sequence d1 (first data sequence) included in the period pd1 and a data sequence d2 (second data sequence) included in the period pd2.

[Step S4] Based on the readout times respectively corresponding to the second counter values included in the data sequences d1 and d2, the controlling unit 1b identifies, in the data sequence d1, a time range t1 (first time range) where one or more second counter values are equal to or greater than one (i. e., positive values), and also identifies, in the data sequence d2, a time range t2 (second time range) where one or more second counter values are equal to or greater than one. Then, the controlling unit 1b determines a common time range tc shared between the time ranges t1 and t2, and estimates the time slot corresponding to the common time range tc as a packet arrival time slot where packets have arrived.

In the example of FIG. 1, the common time range tc shared between the time range t1, where the second counter value in the data sequence d1 is 20, and the time range t2, where the second counter values in the data sequence d2 are consecutively 5 and 15, corresponds to the time slot TSᵢ₊₁.

Therefore, the time slot TSᵢ₊₁ is estimated as the packet arrival time slot. For example, when the packet processing apparatus 1 receives periodic burst traffic, if i=0, the time slots TS₁, TS₆, TS₁₁, and . . . are estimated as the packet arrival time slots.

Conventionally, when it is not possible to read out the counter values in synchronization with the timing of the time slots, it has been difficult to accurately estimate the packet arrival time slots, which represent packet arrival positions on a per-time-slot basis.

On the other hand, in the above-described packet processing apparatus 1, even when the readout timing is asynchronous with respect to the time slots, a data sequence is collected based on counter values obtained at asynchronous readout timings (i.e., readout timings where asynchrony is allowed). Then, the packet processing apparatus 1 divides the collected data sequence into a plurality of equal-length periods, superimposes the divided data sequences, and estimates the packet arrival time slots based on the common time range in which the counter values are equal to or greater than one.

As a result, even the counter values obtained at readout timings asynchronous to the time slots improve the accuracy of estimating the packet arrival time slots, thereby enabling the packet arrival time slots to be estimated accurately.

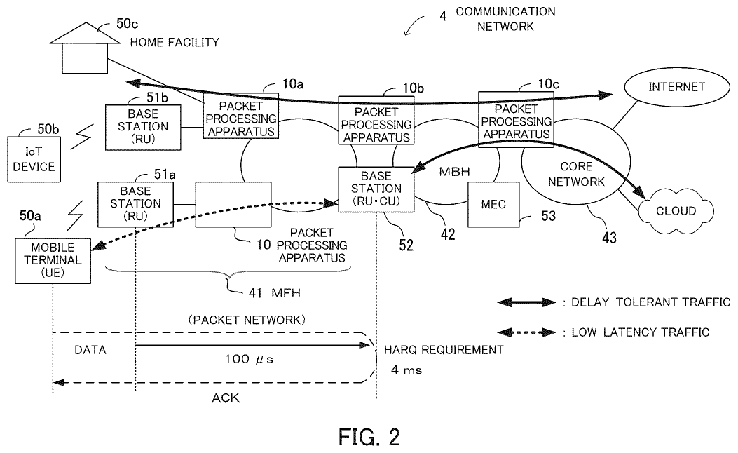

FIG. 2 illustrates an example of a communication network. A communication network 4 to which the packet processing apparatus 1 is applied is, for example, a fifth-generation (5G) network constructed using a 5G mobile communication system. The communication network 4 includes a mobile fronthaul (MFH) 41, a mobile backhaul (MBH) 42, and a core network 43.

Base stations 51a and 51b and packet processing apparatuses 10 and 10a are provided in the MFH 41. The base station 51a is connected to the packet processing apparatus 10, and the base station 51b is connected to the packet processing apparatus 10a. The base stations 51a and 51b are radio units (RUS) having radio frequency processing functions.

A mobile terminal (user equipment, or UE) 50a such as a smartphone is connected to the base station 51a via a wireless interface. An Internet of things (IoT) device 50b is connected to the base station 51b via a wireless interface. In addition, home facility 50c is connected to the packet processing apparatus 10a via a wired interface such as fiber to the home (FTTH).

At the relay point between the MFH 41 and the MBH 42, a packet processing apparatus 10b and a base station 52 are provided. The base station 52 includes a distributed unit (DU) and a centralized unit (CU). Furthermore, a multi-access edge computing (MEC) 53 is provided in the MBH 42, and a packet processing apparatus 10c is provided at the relay point between the MBH 42 and the core network 43. The core network 43 is connected to the Internet and cloud services. The packet processing apparatuses 10, 10a, 10b, and 10c have a packet switching function.

In the communication network 4 for 5G as described above, integration of the packet network is performed on the MFH 41 in order to realize communication services by combining wireless and wired interfaces.

In addition, a retransmission control mechanism called hybrid automatic repeat request (HARQ) operates in communications between the mobile terminal 50a and the base station 52, and it is specified that the reception of an acknowledgement (ACK) is to be performed within 4 ms from data transmission.

Although HARQ was originally confined to the radio domain, wired networks have now emerged between the mobile terminal 50a and the base station 52, as in the communication network 4. In the example of FIG. 2, the base stations 51a and 51b, the packet processing apparatuses 10 and 10a, and the base station 52 are connected via a wired network. Due to the advent of such wired networks, delay constraints have also been established for the MFH 41. For example, the Institute of Electrical and Electronics Engineers (IEEE) specifies a maximum latency of 100 us.

Meanwhile, with the transition of the MFH 41 to a packet-based network, it has come to share the access network with traffic that is tolerant to delay, such as IoT and wired internet traffic. As such, the communication network 4 has a structure in which traffic with a demand for low latency coexists with traffic tolerant to delay.

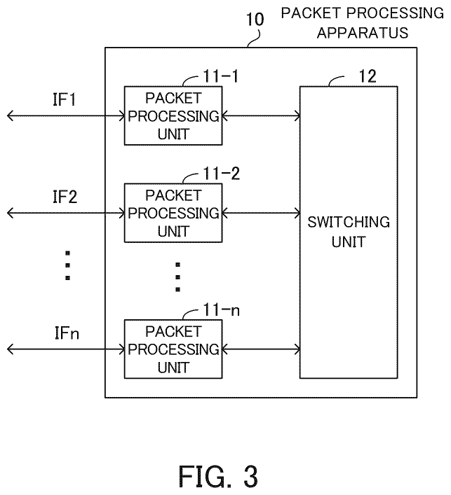

FIG. 3 illustrates an example of a configuration of a packet processing apparatus. The packet processing apparatus 10 includes packet processing units 11-1, . . . , and 11-n (collectively referred to as packet processing units 11) and a switching unit 12.

Packets transmitted through interfaces IF1, . . . , and IFn are subjected to packet processing by the packet processing units 11-1, . . . , and 11-n. After the packet processing, the packets are switched by the switching unit 12 and transmitted to predetermined destinations.

For example, a packet transmitted through the interface IF1 is processed by the packet processing unit 11-1, then switched by the switching unit 12, and subsequently transmitted via the interface IF2 through the packet processing unit 11-2.

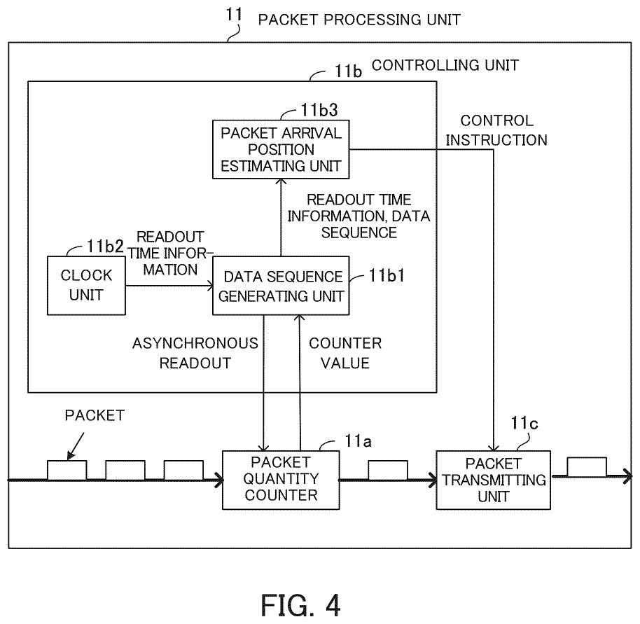

FIG. 4 illustrates an example of functional blocks of a packet processing unit. In the following description, a packet arrival time slot may also be referred to as a “packet arrival position”. Each of the packet processing units 11 includes a packet quantity counter 11a, a controlling unit 11b, and a packet transmitting unit 11c. The controlling unit 11b includes a data sequence generating unit 11b1, a clock unit 11b2, and a packet arrival position estimating unit 11b3. The packet quantity counter 11a implements the functions of the measuring unit 1a in FIG. 1, and the controlling unit 11b implements the functions of the controlling unit 1b in FIG. 1.

The packet quantity counter 11a is, for example, a counter circuit implemented by hardware, and counts the quantity of arrived packets for each time slot. The data sequence generating unit 11b1 starts reading out the counter value at a readout timing synchronized with each time slot. Upon reading out the counter value, the data sequence generating unit 11b1 obtains the time at that moment from the clock unit 11b2 as readout time information. The data sequence generating unit 11b1 generates a data sequence based on the readout counter values, and transmits the data sequence along with the readout time information obtained from the clock unit 11b2 to the packet arrival position estimating unit 11b3.

However, as described above, the readout timings may become asynchronous with respect to the time slots, resulting in deviations in the readout timings. In many cases, the counter value is read out at a timing that is asynchronous to a time slot. In such cases, the time intervals between the readout time information do not coincide with the time intervals synchronized to the time slots.

The packet arrival position estimating unit 11b3 divides the received data sequence into a plurality of periods having an equal interval based on the readout time information, and superimposes the resulting divided data sequences. The packet arrival position estimating unit 11b3 then detects, across the superimposed data sequences, each common time range in which the counter values are equal to or greater than one, and estimates the time slot corresponding to the detected common time range as a packet arrival position.

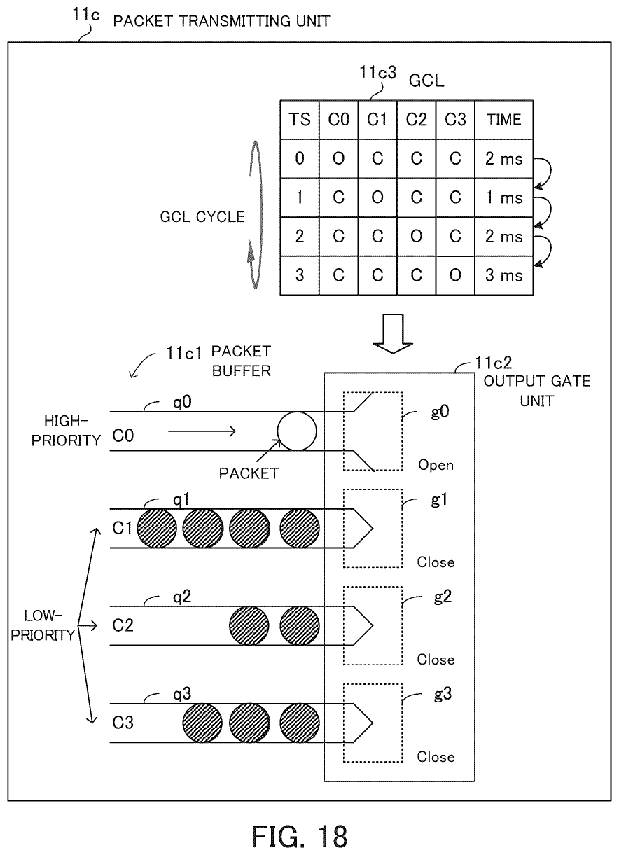

The packet transmitting unit 11c performs packet transmission based on a control instruction from the packet arrival position estimating unit 11b3. The configuration and operation of the packet transmitting unit 11c will be described later with reference to FIG. 18 and subsequent drawings.

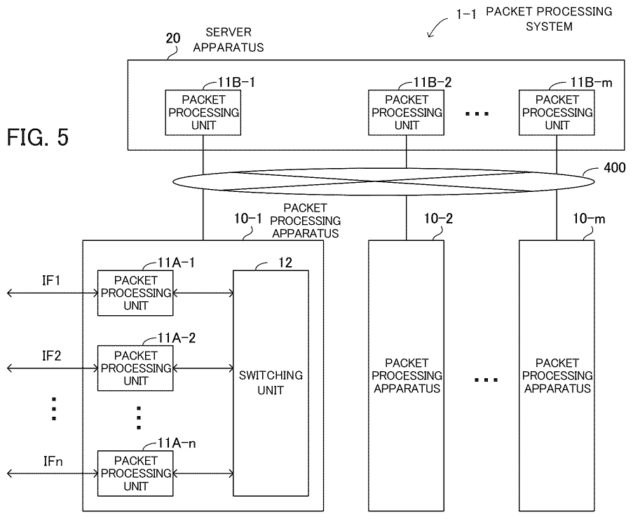

FIG. 5 illustrates an example of a configuration of a packet processing system. A packet processing system 1-1 is a system in which the functions of the packet processing units 11 described above with reference to FIG. 4 are divided and deployed across a server apparatus and a plurality of packet processing apparatuses.

The packet processing system 1-1 includes packet processing apparatuses 10-1, 10-2, . . . , and 10-m and a server apparatus 20. The packet processing apparatus 10-1 includes packet processing units 11A-1, . . . , and 11A-n (hereinafter collectively referred to as packet processing units 11A) and the switching unit 12. The packet processing apparatuses 10-2, . . . , and 10-m have the same configuration as the packet processing apparatus 10-1.

The server apparatus 20 includes packet processing units 11B-1, 11B-2, . . . and 11B-m (collectively referred to as packet processing units 11B). The server apparatus 20 is connected to each of the packet processing apparatuses 10-1, 10-2, . . . , and 10-m via a network 400.

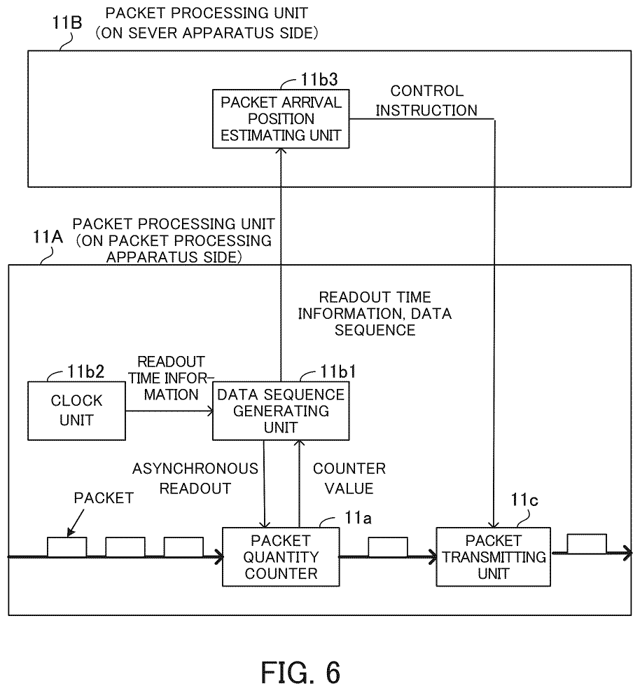

FIG. 6 illustrates an example of functional blocks of packet processing units included in a server apparatus and packet processing apparatuses. Each of the packet processing units 11A of the packet processing apparatuses 10-1, 10-2, . . . , and 10-m includes the packet quantity counter 11a, the data sequence generating unit 11b1, the clock unit 11b2, and the packet transmitting unit 11c. Each of the packet processing units 11B on the server apparatus 20 side includes the packet arrival position estimating unit 11b3.

As described above, in the packet processing system 1-1, the packet arrival position estimating unit 11b3, which is a component responsible for computation processing, is deployed in the server apparatus 20, while the other components are deployed in the packet processing apparatuses 10-1, 10-2, . . . , and 10-m. With such a configuration, the server apparatus 20 is able to collectively control and manage the computation processing for packet arrival position estimation performed for each of the packet processing apparatuses 10-1, 10-2, . . . , and 10-m.

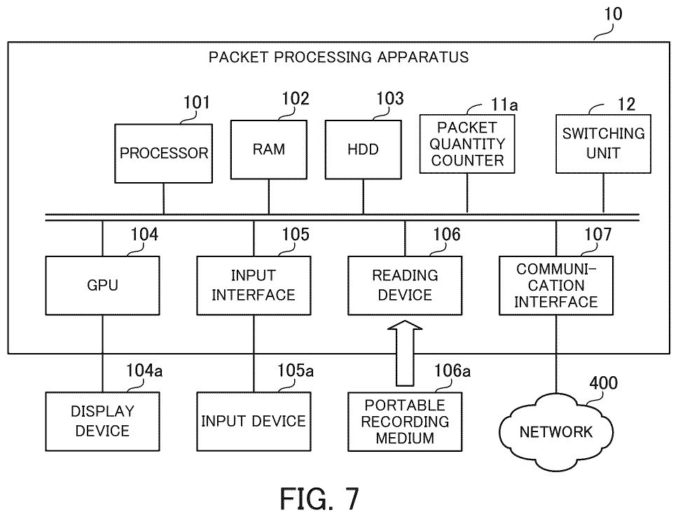

FIG. 7 illustrates an example of the hardware configuration of a packet processing apparatus. The packet processing apparatus 10 is implemented, for example, as a computer such as that illustrated in FIG. 7. The packet processing apparatus 10 includes a processor 101, a random access memory (RAM) 102, a hard disk drive (HDD) 103, a graphics processing unit (GPU) 104, an input interface 105, a reading device 106, a communication interface 107, the packet quantity counter 11a, and the switching unit 12. The processor 101 implements the functions of the controlling unit 11b and also performs overall control of the packet processing apparatus 10. The processor 101 may be, for example, a central processing unit (CPU), a micro processing unit (MPU), a digital signal processor (DSP), an application specific integrated circuit (ASIC), or programmable logic device (PLD). The processor 101 may also be a combination of two or more of a CPU, MPU, DSP, ASIC, and PLD. The packet processing apparatus 10 may include a plurality of processors. Among a plurality of processes performed by the packet processing apparatus 10, one processor may execute a certain process, while another processor may execute a different process. The processor may also be referred to as processor circuitry.

The RAM 102 is used as a main storage device of the packet processing apparatus 10. The RAM 102 temporarily stores at least part of an operating system (OS) program and application programs to be executed by the processor 101. Furthermore, the RAM 102 stores various types of data needed for processing performed by the processor 101.

The HDD 103 is used as an auxiliary storage device of the packet processing apparatus 10. The HDD 103 stores the os program, application programs, and various types of data. As the auxiliary storage device, other types of non-volatile storage devices such as a solid state drive (SSD) may also be used.

A display device 104a is connected to the graphics interface 104. The graphics interface 104 displays images on the display device 104a in accordance with instructions from the processor 101.

An input device 105a is connected to the input interface 105. The input interface 105 transmits signals output from the input device 105a to the processor 101. Examples of the input device 105a include a keyboard and pointing devices. Examples of pointing devices include a mouse, a touch panel, a tablet, a touchpad, and a trackball. A portable recording medium 106a detachably

mounted in the reading device 106. The reading device 106 reads data recorded on the portable recording medium 106a and transmits the data to the processor 101. Examples of the portable recording medium 106a include an optical disk, a magneto-optical disk, and a semiconductor memory. The communication interface 107 transmits and receives data to and from a communication apparatus via the network 400.

Accordingly, the processing functions of the packet processing apparatus 10 may be implemented by the aforementioned hardware configuration. For example, the packet processing apparatus 10 may execute the processing of the embodiment by having the processor 101 run respective predetermined programs.

The packet processing apparatus 10 implements the processing functions of the embodiment by, for example, executing a program recorded on a computer-readable recording medium. The program describing the processing to be executed by the packet processing apparatus 10 may be recorded on various types of recording media.

For example, the program to be executed by the packet processing apparatus 10 may be stored in an auxiliary storage device. The processor 101 loads at least a part of the program from the auxiliary storage device into a main storage device and executes the program.

The program may also be recorded on a portable recording medium such as an optical disk, a memory device, or a memory card. The program stored in the portable recording medium becomes executable after being installed in the auxiliary storage device under the control of the processor 101, for example. Alternatively, the processor 101 may directly read and execute the program from the portable recording medium.

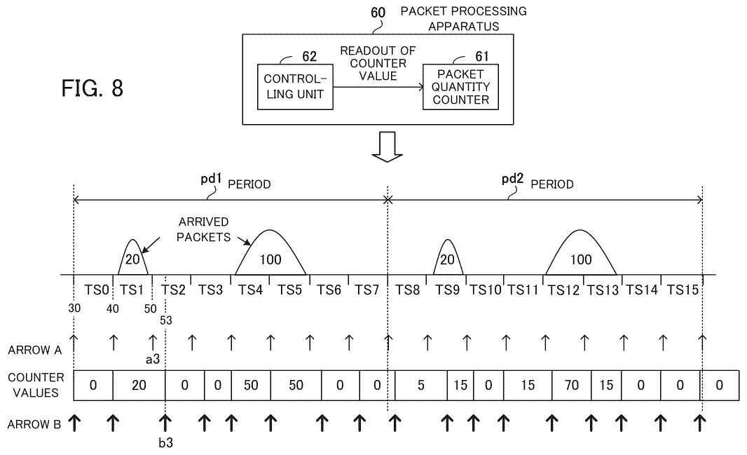

Next, a description will be given, with reference to FIG. 8, of a state prior to improvement, in which the determination of the packet arrival position becomes uncertain when the quantity of arrived packets is read out at a timing asynchronous to the time slot. It is assumed hereinafter that the packet processing apparatus receives periodic burst traffic, and that both the traffic cycle and bandwidth are known in advance.

FIG. 8 illustrates a state where the determination of the packet arrival position becomes uncertain. A packet quantity counter 61 of a packet processing apparatus 60 counts the quantity of arrived packets for each time slot.

In the example of FIG. 8, during a period pd1, packets have arrived in a time slot TS1, and the packet quantity for the time slot TS1 is counted as 20. In addition, packets have arrived across time slots TS4 and TS5, and the packet quantity for the time slots TS4 and TS5 is counted as 100.

Similarly, in a period pd2, packets have arrived in a time slot TS9, and the packet quantity for the time slot TS9 is counted as 20. In addition, packets have arrived across time slots TS12 and TS13, and the packet quantity for the time slots TS12 and TS13 is counted as 100.

A controlling unit 62 of the packet processing apparatus 60 accesses the packet quantity counter 61 based on software (firmware) control by a program, and reads out a counter value counted by the packet quantity counter 61. The controlling unit 62 determines a time slot for which the readout counter value is equal to or greater than one as a packet arrival position.

Here, if the controlling unit 62 reads out the counter value at readout timings (arrows A) spaced at intervals equal to the time slot interval, it is possible to determine in which time slot packets have arrived. However, since the controlling unit 62 concurrently executes processing for other processes, there is a possibility that shifts (delays) in the counter value readout timing may occur due to contention with processing for other processes.

When the counter value is read out at readout timings (arrows B) that deviate from the readout timings having the same interval as that of the time slots (arrows A), it becomes difficult to accurately determine in which time slot packets have arrived.

For example, when packets (packet quantity=20) have arrived in the time slot TS1 between a time 40 and a time 50, it is possible to determine that packets have arrived in the time slot TS1 by reading out the counter value at the readout timing (an arrow a3) located at the time 50, which marks the boundary of the time slot.

On the other hand, due to contention or the like, the readout timing that was originally scheduled to occur at the time 50 may be delayed to a time 53 (i.e., the readout timing indicated by the arrow a3 may shift to that indicated by an arrow b3).

In this case, it becomes difficult to determine whether the packets with a packet quantity of 20 arrived in the time slot TS1 between the time 40 and the time 50, or in a time slot TS2 between the time 50 and the time 53. Alternatively, it may be regarded as having arrived across both time slots TS1 and TS2, spanning from the time 40 to the time 53, making an accurate determination difficult.

As described above, in the process where the controlling unit 62 accesses the packet quantity counter 61 and reads out the counter value, the counter value is not necessarily read out at a readout timing synchronized with the time slot. When the counter value is read out at a timing asynchronous to the time slot, it becomes difficult to accurately determine the packet arrival position, as described above.

It is possible to reduce deviations in the readout timing by replacing the software-based readout processing of the counter value with hardware circuitry, similar to the packet quantity counter 61. However, such modification results in an increased circuit scale, as well as higher component and development costs.

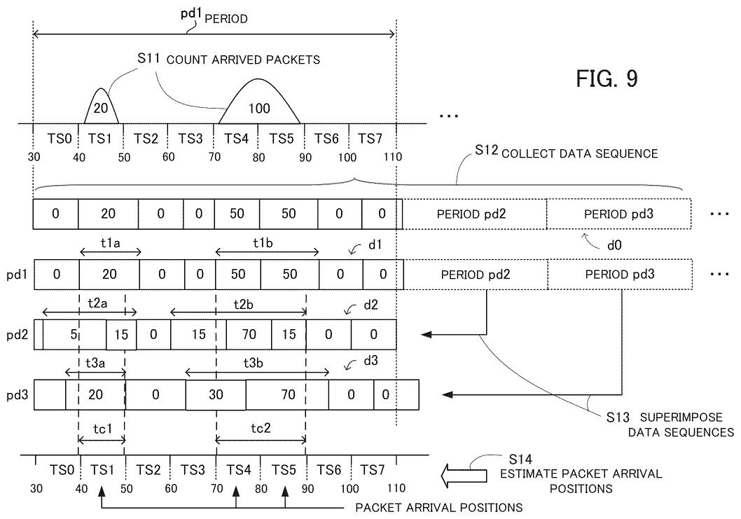

Next, control of the packet processing apparatus 10 will be described with reference to FIG. 9, where the control improves the estimation accuracy of the packet arrival positions when the counter value is read out at timings asynchronous with respect to the time slots.

FIG. 9 illustrates an example of a packet arrival position estimation process.

[Step S11] The packet quantity counter 11a counts the quantity of arrived packets for each time slot. In the example of FIG. 9, packets have arrived in the time slot TS1, and the packet quantity in the time slot TS1 is counted as 20. Additionally, packets have arrived across the time slots TS4 and TS5, and the packet quantity in the time slots TS4 and TS5 is counted as 100. Although not illustrated, it is assumed that burst packets having the same periodicity as the period pd1 will also arrive in each subsequent period.

[Step S12] The controlling unit 11b accesses the packet quantity counter 11a based on software control by a program and reads out the counter value counted by the packet quantity counter 11a. In this case, the controlling unit 11b performs the readout of the counter value counted in step S11 at timings that may be asynchronous with respect to the time slots, and generates the data sequence do in which the counter values read out at possibly asynchronous timings are arranged in the order of their readout timings.

[Step S13] The controlling unit 11b divides the data sequence do into the periods pd1, pd2, pd3, and . . . each having the same cycle length, and superimposes the resulting divided data sequences. In the example of FIG. 9, the data sequences d1, d2, and d3 corresponding to the first, second, and third periods pd1, pd2, and pd3, respectively, are superimposed. The number of samples in each data sequence to be superimposed is arbitrary; however, as the deviations of the readout timings with respect to the time slots increase, the number of samples of the data sequences to be superimposed is increased accordingly.

[Step S14] The controlling unit 11b determines a common time range shared among time ranges in the data sequence d1, the data sequence d2, and the data sequence d3 where the counter values are equal to or greater than one.

In this example, the time ranges where the counter values are equal to or greater than one are: t1a and t1b in the data sequence d1, t2a and t2b in the data sequence d2, and t3a and t3b in the data sequence d3. The time range common to the time ranges t1a, t2a, and t3a is defined as a common time range tc1. Furthermore, the time range common to the time ranges t1b, t2b, and t3b is defined as a common time range tc2.

The controlling unit 11b estimates that the time slots corresponding to the common time ranges are packet arrival positions where packets have arrived. In this example, TS1 is the time slot corresponding to the common time range tc1, and TS4 and TS5 are the time slots corresponding to the common time range tc2. Therefore, the time slots TS1, TS4, and TS5 are estimated as packet arrival positions. That is, in the periods pd1, pd2, pd3, and . . . , time slots corresponding to the time slots TS1, TS4, and TS5 are estimated as packet arrival positions.

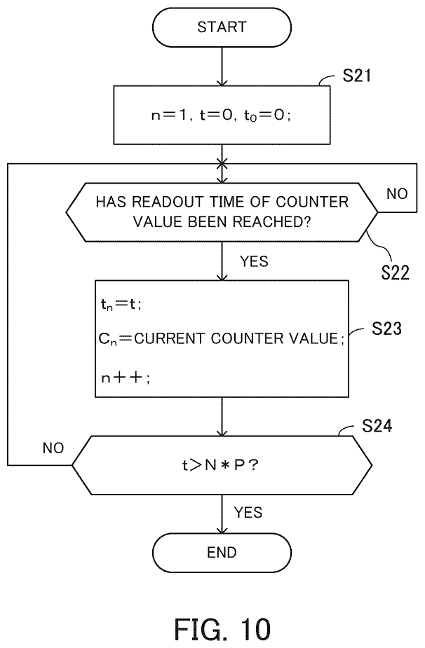

FIG. 10 is a flowchart illustrating an example of a data sequence generation process. In FIG. 10, the parameters are as follows: P is the cycle duration (time) of the period pd; N is the number of samples in the period pd with one cycle length; t is the current time measured from a start time; t₀ is the start time; tₙ is the n-th readout time; and Cₙ is the counter value at the n-th readout.

[Step S21] The controlling unit 11b initializes the parameters by setting n=1, the current time t=0, and the start time t₀=0.

[Step S22] When the readout time of the counter value is reached, the controlling unit 11b proceeds to step S23. The determination that the readout time has been reached is made at predetermined time intervals (e.g., 10 μs). These time intervals are synchronized with the time slots.

[Step S23] The controlling unit 11b accesses the counter to read out the counter value. The controlling unit 11b also obtains the current time. The controlling unit 11b sets the current time as the n-th readout time tₙ (tn=t), and stores both the current time and the n-th counter value Cₙ read out at that time. The value of n is then incremented. As described above, even if, due to contention or

the like, it is not actually possible to read out the counter value at predetermined time intervals of the readout timings, resulting in deviations in the readout timings, the counter value is continuously read out. When deviations occur in the readout timings, there may be a case where the intervals of the readout times stored together with the counter values do not match the predetermined time intervals.

[Step S24] The controlling unit 11b determines whether t>N*P. When t>N*P, the controlling unit 11b determines that a sufficient data sequence has been obtained for estimating packet arrival positions, and ends the data sequence generation process. If t≤N*P, the controlling unit 11b returns to step S22 and continues the data sequence generation process.

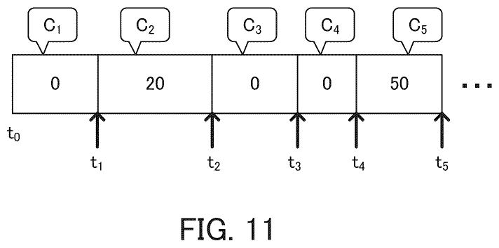

FIG. 11 illustrates an example of the flow of the data sequence generation process. FIG. 11 depicts the flow of the data sequence generation process corresponding to the parameters presented in the flowchart of FIG. 10. At a time t₁, which has elapsed from the start time t₀, a first counter value C₁ (packet quantity=0) is read out. Subsequently, at a time t₂, which has elapsed from the time t₁, a second counter value C₂ (packet quantity=20) is read out.

Further, at a time t₃, which has elapsed from the time t₂, a third counter value C₃ (packet quantity=0) is read out, and at a time t₄, which has elapsed from the time t₃, a fourth counter value C₄ (packet quantity=0) is read out. In addition, at a time t₅, which has elapsed from the time t₄, a fifth counter value C₅ (packet quantity=50) is read out. Thereafter, counter values continue to be read out to generate a data sequence until the time t exceeds N*P.

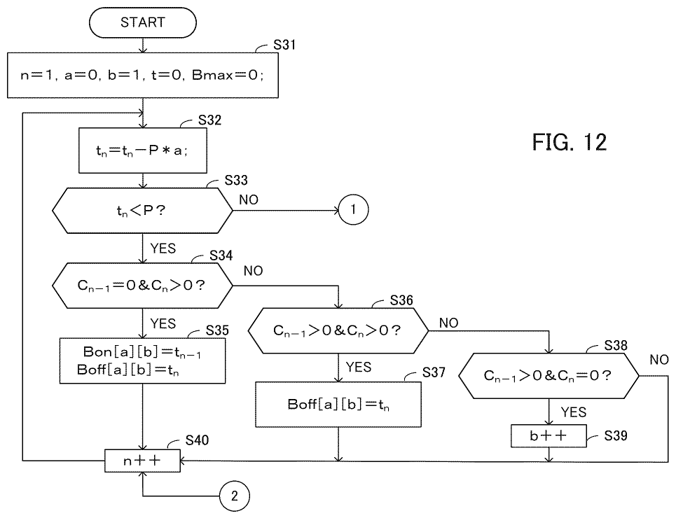

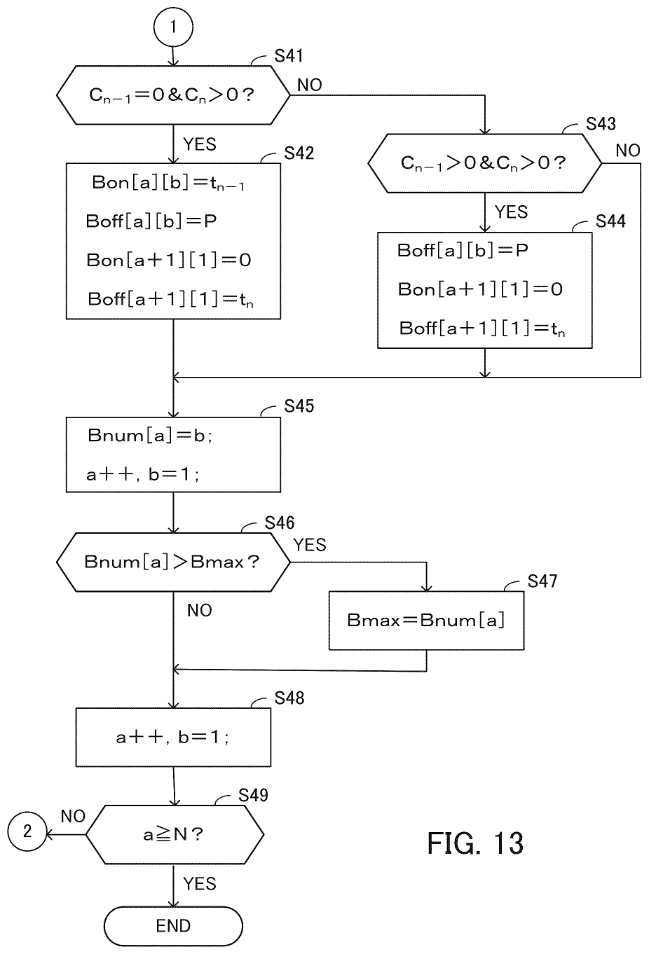

FIGS. 12 and 13 are flowcharts illustrating an example of a packet arrival time detection process. The flowcharts represent a process for detecting the time range within one period during which packets have arrived.

In FIGS. 12 and 13, the parameters are as follows: P is the cycle duration (time) of the period pd; N is the number of samples in the period pd with one cycle length; t is the relative time within one cycle; tₙ is the n-th readout time; and Cₙ is the counter value at the n-th readout.

In addition, a is the current cycle; b is the current burst number within one cycle; and Bon[m][n] is the start time of the n-th burst in the period pd of the m-th cycle. Furthermore, Boff[m][n] is the end time of the n-th burst in the period pd of the m-th cycle; Bnum[m] is the number of bursts in the period pd of the m-th cycle; and Bmax is the maximum number of bursts.

[Step S31] The controlling unit 11b initializes the parameters by setting n=1, the current cycle a=0, the current burst number within one cycle b=1, the relative time within one cycle t=0, and Bmax=0.

[Step S32] The controlling unit 11b corrects the n-th readout time tₙ to the relative time within one cycle (tₙ=tₙ−P*a).

[Step S33] The controlling unit 11b determines whether tₙ<P. If tₙ<P, the process proceeds to step S34. If tₙ>P, the process proceeds to step S41. Note that, tₙ<P indicates that the counter value Cₙ at the n-th readout is within one cycle, while tₙ>P indicates that the counter value Cₙ at the n-th readout spans across cycles.

[Step S34] The controlling unit 11b determines whether Cₙ₋₁=0 and Cₙ>0. If Cₙ₋₁=0 and Cₙ>0 holds, the process proceeds to step S35; otherwise, the process proceeds to step S36. The condition Cₙ₋₁=0 and Cₙ>0 in step S34 corresponds to a state in which, within one cycle, the counter value changes from zero to a value equal to or greater than one.

[Step S35] The controlling unit 11b detects the start time and the end time of burst packets. Specifically, the controlling unit 11b sets the start time of the b-th burst in the period pd of the a-th cycle, Bon[a][b], to the (n−1)-th readout time tₙ₋₁ (i.e., Bon[a][b]=tₙ₋₁ ). The controlling unit 11b sets the end time of the b-th burst in the period pd of the a-th cycle, Boff[a][b], to the n-th readout time tₙ (i.e., Boff[a][b]=tₙ). The process then proceeds to step S40.

[Step S36] The controlling unit 11b determines whether Cₙ₋₁>0 and Cₙ>0. If Cₙ₋₁>0 and Cₙ>0 holds, the process proceeds to step S37; otherwise, the process proceeds to step S38. The condition Cₙ₋₁>0 and Cₙ>0 in step S36 corresponds to a state in which, within one cycle, the counter value successively transitions to values equal to or greater than one.

[Step S37] The controlling unit 11b updates the end time of the burst packets. Specifically, the controlling unit 11b sets the end time of the b-th burst in the period pd of the a-th cycle, Boff[a][b], to the n-th readout time tₙ (i. e., Boff[a][b]=tₙ). The process then proceeds to step S40.

[Step S38] The controlling unit 11b determines whether Cₙ₋₁>0 and Cₙ=0. If Cₙ₋₁>0 and Cₙ=0 holds, the process proceeds to step S39; otherwise, the process proceeds to step S40. The condition Cₙ₋₁>0 and Cₙ=0 in step S38 corresponds to a state in which, within one cycle, the counter value changes from zero to a value equal to or greater than one.

[Step S39] The controlling unit 11b increments b.

[Step S40] The controlling unit 11b increments n and returns to step S32.

[Step S41] The controlling unit 11b determines whether Cₙ₋₁=0 and Cₙ>0. If Cₙ₋₁=0 and Cₙ>0 holds, the process proceeds to step S42; otherwise, the process proceeds to step S43. The condition Cₙ₋₁=0 and Cₙ>0 in step S41 corresponds to a state in which the counter value, across cycles, changes from zero to a value equal to or greater than one.

[Step S42] The controlling unit 11b detects the start times and the end times of burst packets. Specifically, the controlling unit 11b sets the start time of the b-th burst in the period pd of the a-th cycle, Bon[a][b], to the (n−1)-th readout time tₙ₋₁ (i.e., Bon[a][b]=tₙ₋₁ ). The controlling unit 11b also sets the end time of the b-th burst in the period pd of the a-th cycle, Boff[a][b], to the cycle duration (time) P of the period pd (i.e., Boff[a][b]=P). In addition, the controlling unit 11b sets the start time of the first burst in the period pd of the (a+1)-th cycle, Bon[a+1][1], to zero (i.e., Bon[a+1][1]=0). Furthermore, the controlling unit 11b sets the end time of the first burst in the period pd of the (a+1)-th cycle, Boff[a+1][1], to the n-th readout time tₙ (i. e., Boff[a+1][1]=tₙ). The process then proceeds to step S45.

[Step S43] The controlling unit 11b determines whether Cₙ₋₁>0 and Cₙ>0. If Cₙ₋₁>0 and Cₙ>0 holds, the process proceeds to step S44; otherwise, the process proceeds to step S45. The condition Cₙ₋₁>0 and Cₙ>0 in step S43 corresponds to a state in which counter values of one or greater continue consecutively across cycles.

[Step S44] The controlling unit 11b updates the end times of burst packets. In this case, the controlling unit 11b sets the end time of the b-th burst in the period pd of the a-th cycle, Boff[a][b], to the cycle duration (time) P of the period pd (i.e., Boff[a][b]=P). The controlling unit 11b also sets the start time of the first burst in the period pd of the (a+1)-th cycle, Bon[a+1][1], to zero (i.e., Bon[a+1][1]=0). Furthermore, the controlling unit 11b sets the end time of the first burst in the period pd of the (a+1)-th cycle, Boff[a+1][1], to the n-th readout time tₙ (i.e., Boff[a+1][1]=tₙ).

[Step S45] The controlling unit 11b sets the number of bursts in the period pd of the a-th cycle, Bnum[a], to b (i.e., Bnum[a]=b). The controlling unit 11b also increments a and sets b to one.

[Step S46] The controlling unit 11b determines whether Bnum[a]>Bmax. If Bnum[a]>Bmax holds, the process proceeds to step S47; otherwise, the process proceeds to step S48.

[Step S47] The controlling unit 11b sets the maximum number of bursts Bmax to the number of bursts in the period pd of the a-th cycle, Bnum[a] (i.e., Bmax=Bnum[a]).

[Step S48] The controlling unit 11b increments a and sets b to one.

[Step S49] The controlling unit 11b determines whether a≥N. If a≥N holds, the controlling unit 11b ends the process. If a<N, the controlling unit 11b returns to step S40.

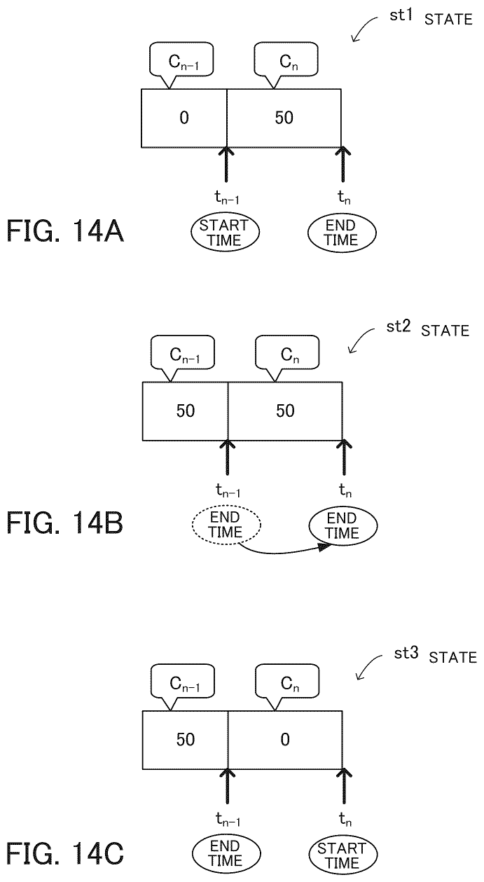

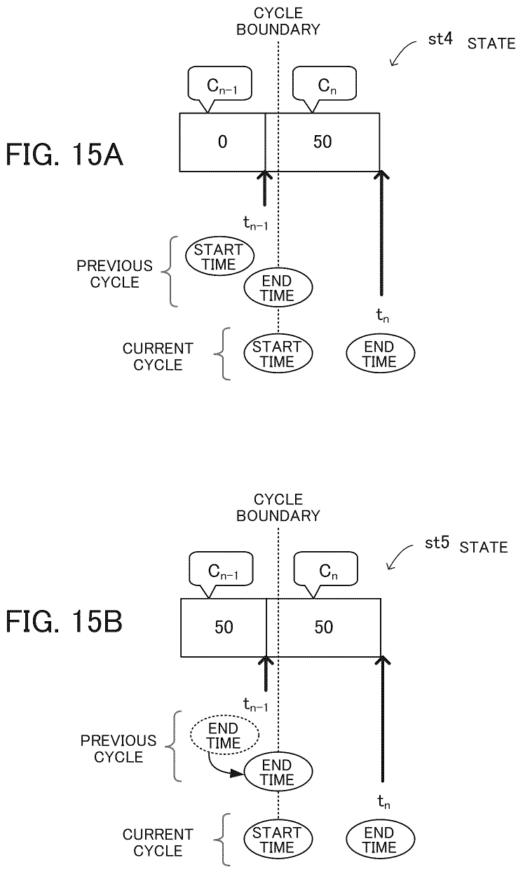

FIGS. 14A to 14C and FIGS. 15A and 15B illustrate examples of counter value states during packet arrival time detection. A state st1 represents the case where Cₙ₋₁=0 and Cₙ>0 within one cycle. This corresponds to the “YES” branch in the processing of step S34 in FIG. 12, indicating a state in which the counter value changes from zero to a value equal to or greater than one within one cycle. In the example of FIG. 14A, Cₙ₋₁=0 and Cₙ=50. The (n−1)-th readout time tₙ₋₁ is the burst start time, and the n-th readout time tₙ is the burst end time.

A state st2 represents the case where Cₙ₋₁>0 and Cₙ>0 within one cycle. This corresponds to the “YES” branch in the processing of step S36 in FIG. 12, indicating a state in which, within one cycle, the counter value successively transitions to values equal to or greater than one. In the example of FIG. 14B, Cₙ₋₁=50 and Cₙ=50, and the burst end time is updated from the (n−1)-th readout time tₙ₋₁ to the n-th readout time tn.

A state st3 represents the case where Cₙ₋₁>0 and Cₙ=0 within one cycle. This corresponds to the “YES” branch in the processing of step S38 in FIG. 12, indicating a state in which the counter value changes from a value equal to or greater than one to zero within one cycle. In the example of FIG. 14C, Cₙ₋₁=50 and Cₙ=0, and the (n−1)-th readout time tₙ₋₁ is the burst end time and the n-th readout time tn is the burst start time.

A state st4 represents the case where Cₙ₋₁=0 and Cₙ>0 across cycles. This corresponds to the “YES” branch in the processing of step S41 in FIG. 13, indicating a state in which the counter value changes from zero to a value equal to or greater than one across cycles. In the example of FIG. 15A, Cₙ₋₁=0 and Cₙ=50. In the previous cycle, the (n−1)-th readout time tₙ₋₁ is the burst start time and the cycle boundary is the burst end time. In the current cycle, the cycle boundary becomes the burst start time, and the n-th readout time tₙ becomes the burst end time.

A state st5 represents the case where Cₙ₋₁>0 and Cₙ>0 across cycles. This corresponds to the “YES” branch in the processing of step S43 in FIG. 13, indicating a state in which, across cycles, the counter value successively transitions to values equal to or greater than one. In the example of FIG. 15B, Cₙ₋₁=50 and Cₙ=50. In the previous cycle, the burst end time is updated to the cycle boundary from the (n−1)-th readout time tₙ₋₁ . In the current cycle, the cycle boundary becomes the burst start time, and the n-th readout time th becomes the burst end time.

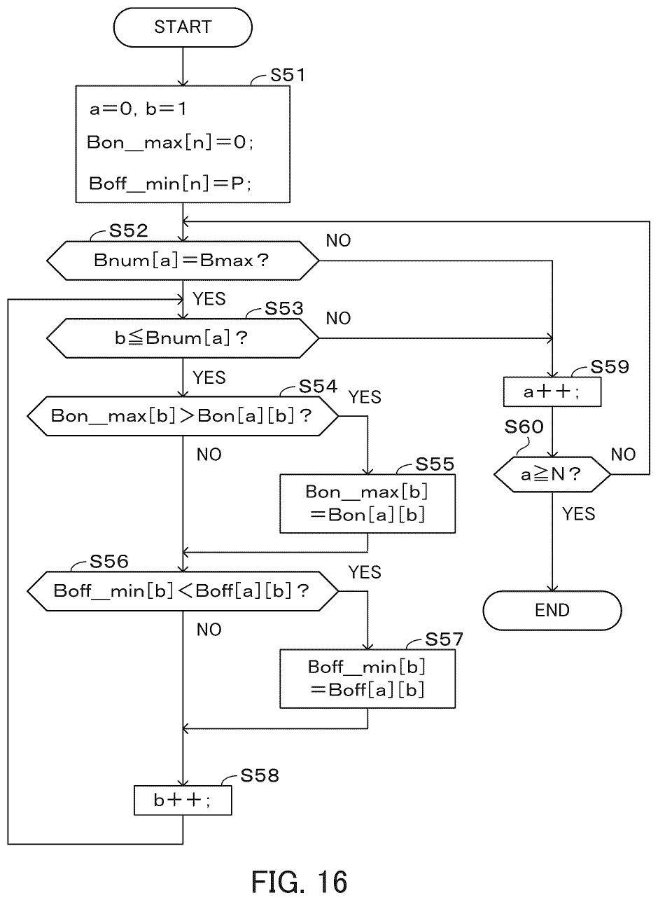

FIG. 16 is a flowchart illustrating an example of a time window narrowing process performed during packet arrival position estimation. Regarding the newly introduced parameters presented in FIG. 16, Bon_max[n] denotes the maximum start time of the n-th burst, and Boff_min[n] denotes the minimum end time of the n-th burst.

[Step S51] The controlling unit 11b initializes the parameters by setting the current cycle a=0, the current burst number within one cycle b=1, the maximum start time of the n-th burst Bon_max[n]=0, and the minimum end time of the n-th burst Boff_min[n]=P.

[Step S52] The controlling unit 11b determines whether the number of bursts in the period pd of the a-th cycle, Bnum[a], is equal to the maximum number of bursts Bmax (i.e., whether Bnum[a]=Bmax). If Bnum[a]=Bmax, the process proceeds to step S53. If Bnum[a]≠Bmax, the process proceeds to step S59.

[Step S53] The controlling unit 11b determines whether b≤Bnum[a]. If b≤Bnum[a], the process proceeds to step S54; if b>Bnum[a], the process proceeds to step S59.

[Step S54] The controlling unit 11b determines whether Bon_max[b]>Bon[a][b]. If Bon_max[b]>Bon[a][b], the process proceeds to step S55; if Bon_max[b]≤Bon[a][b], the process proceeds to step S56.

[Step S55] The controlling unit 11b sets Bon_max[b] to Bon[a][b] (i. e., Bon_max[b]=Bon[a][b]).

[Step S56] The controlling unit 11b determines whether Boff_min[b]<Boff[a][b]. If Boff_min[b]<V Boff[a][b], the process proceeds to step S57; if Boff_min[b]≥Boff[a][b], the process proceeds to step S58.

[Step S57] The controlling unit 11b sets Boff_min[b] to Boff[a][b] (i.e., Boff_min[b]=Boff[a][b]).

[Step S58] The controlling unit 11b increments b. The process then returns to step S53.

[Step S59] The controlling unit 11b increments a.

[Step S60] The controlling unit 11b determines whether a≥N. If a≥N, the process ends. If a<N, the process returns to step S52.

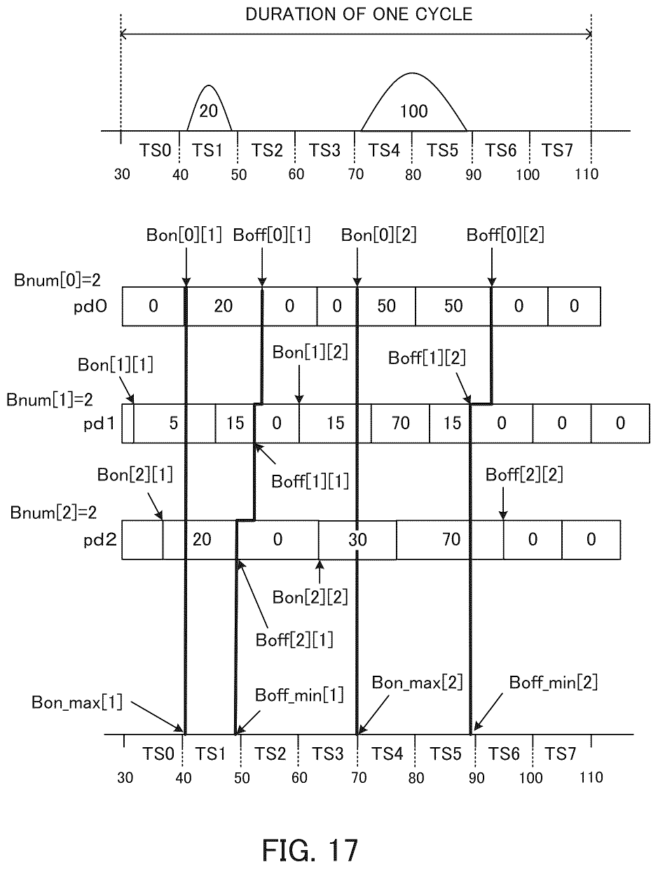

FIG. 17 illustrates an example of the time window narrowing process performed during packet arrival position estimation. Since the number of bursts in the periods pd0, pd1, and pd2 is two in each case, Bnum[0]=2.

Here, in the period pd0, the start time of the first burst (a burst of arrived packets with a packet quantity of 20) is Bon[0][1]. In the period pd1, the start time of the first burst (a burst consisting of consecutively arrived packets with packet quantities of 5 and 15) is Bon[1][1]. In the period pd2, the start time of the first burst (a burst consisting of arrived packets with a packet quantity of 20) is Bon[2][1].

In this case, as illustrated in FIG. 17, the maximum start time among the start times of the periods pd0, pd1, and pd2 is Bon[0][1] since Bon[1][1]<Bon[2][1]<Bon[0][1]. Therefore, the maximum start time of the first burst across the periods pd0, pd1, and pd2, denoted as Bon_max[1], is Bon[0][1] (i.e., Bon_max[1]=Bon[0][1]).

On the other hand, the end time of the first burst in the period pd0 is Boff[0][1]; in the period pd1, it is Boff[1][1]; and in the period pd2, it is Boff[2][1].

In this case, as illustrated in FIG. 17, the minimum end time among the end times of the periods pd0, pd1, and pd2 is Boff[2][1] since Boff[2][1] <Boff[1][1]<Boff[0][1]. Therefore, the minimum end time of the first burst across the periods pd0, pd1, and pd2, denoted as Boff_min[1], is Boff[2][1] (i.e., Boff_min[1]=Boff[2][1]).

The time width of the common time window of the first burst across the periods pd0, pd1, and pd2 is the time interval between Bon_max[1] and Boff_min[1], which corresponds to the time interval between Bon[0][1] and Boff[2][1]. Since the time interval between Bon[0][1] and Boff[2][1] corresponds to the time slot TS1, the packet arrival position of the first burst is estimated to be the time slot TS1.

Similarly, in the period pd0, the start time of the second burst (arrived packets with packet quantities of 50 followed by 50) is Bon[0][2]. In the period pd1, the start time of the second burst (arrived packets with packet quantities of 15, 70, and 15 in succession) is Bon[1][2]. In the period pd2, the start time of the second burst (arrived packets with packet quantities of 30 followed by 70) is Bon[2][2].

In this case, as illustrated in FIG. 17, the maximum start time among the start times of the periods pd0, pd1, and pd2 is Bon[0][2] since Bon[2][2]<Bon[1][2]<Bon[0][2]. Therefore, the maximum start time of the second burst across the periods pd0, pd1, and pd2, denoted as Bon_max[2], is Bon[0][2] (i.e., Bon_max[2]=Bon[0][2].

On the other hand, the end time of the second burst in the period pd0 is Boff[0][2]; in the period pd1, it is Boff[1][2]; and in the period pd2, it is Boff[2][2].

In this case, as illustrated in FIG. 17, the minimum end time among the end times of the periods pd0, pd1, and pd2 is Boff[1][2] since Boff[1][2]<Boff[0][2]<Boff[2][2]. Therefore, the minimum end time of the second burst across the periods pd0, pd1, and pd2, denoted as Boff_min[2], is Boff[1][2] (i.e., Boff_min[2]=Boff[1][2].

The time width of the common time window of the second burst across the periods pd0, pd1, and pd2 is the time interval between Bon_max[2] and Boff_min[2], which corresponds to the time interval between Bon[0][2] and Boff[1][2]. Since the time interval between Bon[0][2] and Boff[1][2] corresponds to the time slots TS4 and TS5, the packet arrival position of the second burst is estimated to be the time slots TS4 and TS5.

Next, a packet processing apparatus equipped with a time aware shaper (TAS) function will be described. As described above with reference to FIG. 2, certain packet networks within the communication network 4 are expected to achieve low latency in packet transmission. To address this need, particular attention is being given to IEEE 802.1Qbv—Enhancements for Scheduled Traffic (TAS), which is aimed at achieving low latency within packet switches, within the set of low-latency-related standards known as IEEE 802.1 TSN.

FIG. 18 illustrates an example of a packet transmitting unit having a TAS function. In the following description, it is assumed that the packet processing apparatus 10 receives high-priority traffic (high-priority packets) as periodic burst traffic, and that the traffic cycle and bandwidth are known in advance. Furthermore, it is assumed that time synchronization is achieved using, for example, precision time protocol (PTP), and that the high-priority traffic always arrives in the same time slot TS.

The packet transmitting unit 11c in the packet processing apparatuses 10 includes a packet buffer 11c 1, an output gate unit 11c 2, and a gate control list (GCL) 11c3. The packet buffer 11c 1 includes queues q0, . . . , and q3 (the number of queues is arbitrary; however, IEEE 802.1Qbv specifies up to eight classes of queues). The queue q0 stores high-priority packets of a class C0. The queues q1, q2, and q3 store low-priority packets of classes C1, C2, and C3, respectively.

The output gate unit 11c 2 includes output gates g0, . . . , and g3, each corresponding to output terminals of the queues q0, . . . , and q3, respectively. When the output gate g0, . . . , and g3 is open, packets queued in the corresponding queue are transmitted. When the output gate g0, . . . , and g3 is closed, the transmission of queued packets is halted.

The GCL 11c3 a list that includes the time slots TS, the classes C0, . . . , C3, and time entries, and is used to control the opening and closing of the output gates in the output gate unit 11c2.

In the GCL 11c3, the open or close state of each output gate for each time slot TS is predetermined. For example, in the time slot TS0 as depicted in FIG. 18, the output gate state is configured as (TS0: 0, C, C, C), where “O” indicates “open” and “C” indicates “closed”.

That is, in the time slot TS0, the output gate g0 is set to open, allowing high-priority packets of the class C0 to be transmitted from the queue q0. In addition, in the time slot TS0, the output gates g1, . . . , and g3 are set to closed, thereby preventing the transmission of low-priority packets of the classes C1, C2, and C3 from the queues q1, q2, and q3, respectively.

Furthermore, the GCL cycle is configured to match the traffic cycle of burst packets. In the example of FIG. 18, the output gate state for the time slot TS0, (TS0: O, C, C, C), continues for 2 ms as the GCL cycle, after which the output gate state for the next time slot TS1 transitions to (TS1: C, O, C, C). Then, after the state (TS1: C, O, C, C) continues for 1 ms, the output gate state for the next time slot TS2 becomes (TS2: C, C, O, C).

Furthermore, after the state (TS2: C, C, O, C) continues for 2 ms, the output gate state for the next time slot TS3 transitions to (TS3: C, C, C, O). Then, after the state (TS3: C, C, C, O) continues for 3 ms, the state returns to (TS0: 0, C, C, C), and this cycle is repeated in the same manner thereafter.

Here, in the above configuration, for example, considering the class C0, when the transmission timing corresponds to the time slot TS0, only high-priority packets of the class C0 are transmitted, and packets of the other classes C1, C2, and C3 are not transmitted, regardless of whether there is traffic present in those classes.

Similarly, considering the class C1, when the transmission timing corresponds to the time slot TS1, only low-priority packets of the class C1 are transmitted, and packets of the other classes C0, C2, and C3 are not transmitted, regardless of traffic presence. In this way, TAS guarantees that each class is granted an exclusive packet transmission timing at regular intervals.

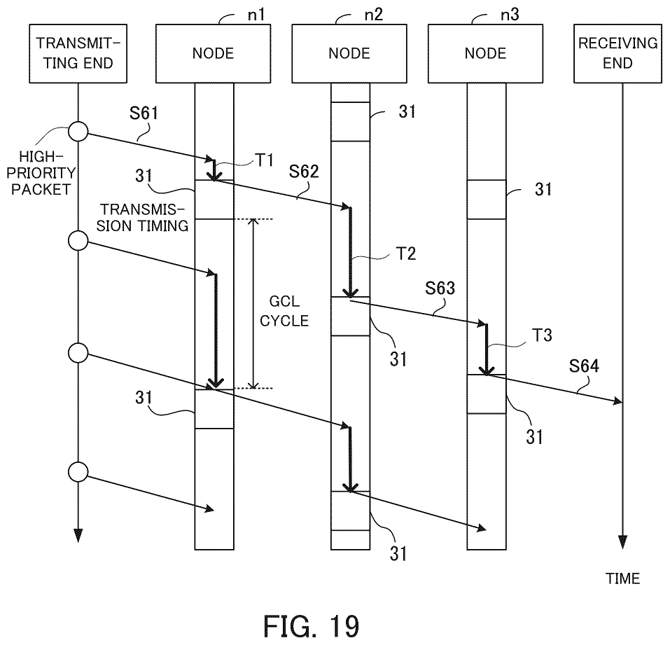

FIG. 19 illustrates an example of the operation of TAS. Nodes n1, n2, and n3 are packet transmission nodes that support the TAS function. These nodes n1, n2, and n3 represent examples packet processing apparatuses of installed between the base stations 51a and 51b and the base station 52.

[Step S61] A high-priority packet of the class C0 is transmitted from the transmitting end to the node n1, and the high-priority packet is received at the node n1.

[Step S62] Since a transmission timing 31 for the class C0 periodically recurs at the node n1 after a lapse of time T1 from the reception of the packet, the node n1 transmits the high-priority packet to the node n2 at the recurring transmission timing 31.

[Step S63] The node n2 receives the packet transmitted from the node n1. Since the transmission timing 31 for the class C0 periodically recurs at the node 2 after a lapse of time T2 from the reception of the packet, the node n2 transmits the high-priority packet to the node n3 at the recurring transmission timing 31.

[Step S64] The node n3 receives the packet transmitted from the node n2. Since the transmission timing 31 for the class C0 periodically recurs at the node n3 after a lapse of time T3 from the reception of the packet, the node n3 transmits the high-priority packet to the receiving end at the recurring transmission timing 31.

Here, since the transmission timing for the class C0 recurs within the GCL cycle, each of the times T1, T2, and T3 does not exceed the GCL cycle. In other words, with TAS, the upper bound of the delay between nodes may be defined by the GCL cycle.

The network delay time for packet transmission from the transmitting end to the receiving end via the nodes n1, n2, and n3 is given by: (Network Delay Time)≤(GCL Cycle)×(Number of Nodes)+(Propagation Delay between the Transmitting End and Node n1)+(Propagation Delay between Nodes)+(Propagation Delay between Node n3 and the Receiving End).

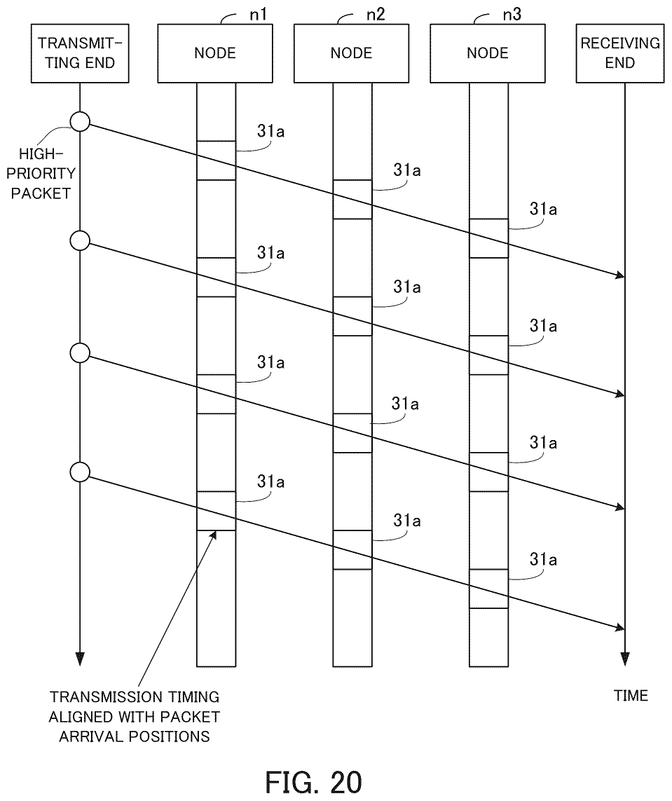

FIG. 20 illustrates another example of the operation of TAS. While in the control method depicted in FIG. 19, the upper bound of delay is defined by the GCL cycle, FIG. 20 illustrates a control state that achieves even lower latency. In this example, at each of the nodes n1, n2, and n3, the transmission timing for high-priority packets of the class C0 is set as transmission timing 31a, which is aligned with the respective packet arrival positions. By opening the output gate for high-priority packets at this transmission timing 31a, it is possible to eliminate the times T1, T2, and T3 depicted in FIG. 19, thereby achieving further reduction in latency.

In the case of FIG. 20, the network delay time for packet transmission from the transmitting end to the receiving end via the nodes n1, n2, and n3 is given by: (Network Delay Time)=(Propagation Delay between the Transmitting End and Node n1)+(Propagation Delay between Nodes)+(Propagation Delay between Node n3 and the Receiving End).

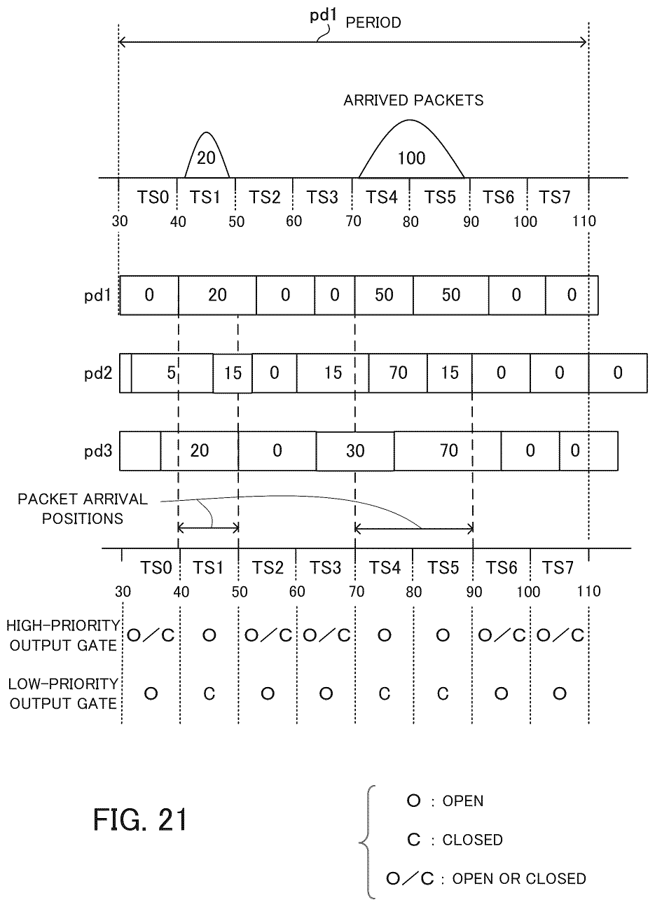

FIG. 21 illustrates the open and close states of the output gates in relation to the packet arrival positions. In the packet processing apparatus 10, based on the control described above with reference to FIG. 9, the packet arrival positions are estimated to be the time slots TS1, TS4, and TS5. Accordingly, the packet transmitting unit 11c

opens the output gate g0 of the high-priority queue q0 during the time ranges corresponding to the time slots TS1, TS4, and TS5, based on control instructions transmitted from the controlling unit 11b, which include estimated information on packet arrival positions. In addition, based on the control instructions, the packet transmitting unit 11c closes the output gates g1, g2, and g3 of the low-priority queues q1, q2, and q3.

Further, during time ranges other than the time slots TS1, TS4, and TS5, the packet transmitting unit 11c either opens or closes the output gate g0 of the high-priority queue q0 (either state is acceptable), while opening the output gates g1, g2, and g3 of the low-priority queues q1, q2, and q3.

As described above, in the packet processing apparatus 10, the output gate of the high-priority packet buffer is opened in accordance with the time slots corresponding to the estimated packet arrival positions. As a result, it is possible to perform packet transmission as illustrated in FIG. 20, thereby enabling low-latency packet transmission.

The GCL configuration will now be described for opening the output gate of the high-priority packet buffer in accordance with the time slots corresponding to packet arrival positions.

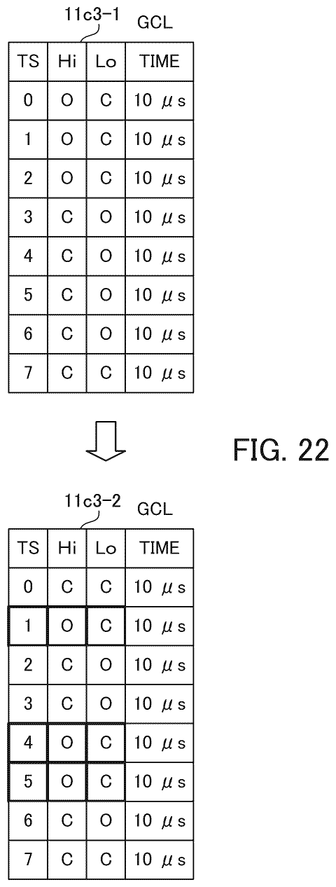

FIG. 22 illustrates an example of configuration states of the GCL. In FIG. 22, “Hi” indicates the high-priority class, and “Lo” indicates the low-priority classes. A GCL 11c3-1 represents an initial configuration state. In this example, it is assumed that the traffic cycle of the high-priority packets is 80 μs and the bandwidth requirement is within 3 time slots (37.5%), both known in advance. However, since the time slots TS in which packets will arrive are not yet determined in the initial stage of operation, the open positions in the GCL 11c3-1 are configured arbitrarily.

A GCL 11c3-2 represents an updated configuration state. In FIG. 21, the packet arrival positions of the high-priority packets are estimated to be in the time slots TS1, TS4, and TS5. Accordingly, in the GCL 11c3-2, for the time slots TS1, TS4, and TS5, Hi (the high-priority class) is set to open and Lo (the low-priority classes) is set to close, and the GCL is updated accordingly.

As a result, in the packet processing apparatus 10, the output gate for high-priority traffic is always open at the timing when the high-priority traffic arrives, while the output gates for low-priority traffic remain closed. This configuration allows the high-priority traffic to pass through with minimal delay, without being affected by interference from the low-priority traffic.

The packet processing apparatus and the packet processing system of the embodiment described above may be implemented by a computer. In this case, a program describing the processing operations corresponding to the needed functions of the packet processing apparatus and the packet processing system is provided. By executing this program on a computer, the above-described processing functions are realized.

The program describing the processing operations may be stored on a computer-readable recording medium. Examples of computer-readable recording media include magnetic storage devices, optical discs, magneto-optical recording media, semiconductor memories, and the like. Magnetic storage devices include hard disk drives (HDDs), flexible disks (FDs), magnetic tapes, and the like. Optical discs include CD-ROMS, CD-RWs, and the like. Magneto-optical recording media include magneto-optical (MO) disks and the like.

When distributing the program, for example, a portable recording medium such as a CD-ROM on which the program is recorded may be sold. Alternatively, the program may be stored in a storage unit of a server computer and transferred to another computer via a network.

The computer that executes the program may store in its own storage unit the program recorded on a portable recording medium or the program transferred from a server computer. The computer then reads the program from its storage unit and executes processing in accordance with the program. Alternatively, the computer may read the program directly from the portable recording medium and execute processing in accordance with the program.

Further, the computer may sequentially perform processing according to each program received every time a program is transferred from a server computer connected via a network. In addition, at least a part of the above processing functions may be implemented by electronic circuits such as DSPs, ASICS, PLDs, or the like.

According to one aspect, it is possible to improve the estimation accuracy of the packet arrival time slots.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A packet processing apparatus comprising:
a counter configured to count a quantity of packets that have arrived for each of a plurality of time slots to obtain respective first counter values; and
a processor configured to:
read out, at timings that may be asynchronous to the plurality of time slots, the first counter values to obtain respective second counter values, collect the second counter values read out at the timings and corresponding readout times, and generate a data sequence in which the collected second counter values are arranged in an order corresponding to the timings;
divide the data sequence into a plurality of periods of equal length based on the readout times to obtain a first period and a second period, and superimpose, with respect to the first period and the second period, a first data sequence included in the first period and a second data sequence included in the second period; and
determine, based on the readout times corresponding to the second counter values included in the first data sequence and the second data sequence, a first time range during which one or more of the second counter values included in the first data sequence are equal to or greater than one and a second time range during which one or more of the second counter values included in the second data sequence are equal to or greater than one, identify a common time range shared between the first time range and the second time range, and estimate time slots corresponding to the common time range as packet arrival time slots in which the packets have arrived.

2. The packet processing apparatus according to claim 1, further comprising:
a packet transmitter configured to include a high-priority packet buffer that buffers high-priority packets, a low-priority packet buffer that buffers low-priority packets, a first output gate that opens and closes an output of the high-priority packet buffer, and a second output gate that opens and closes an output of the low-priority packet buffer,
wherein, during the packet arrival time slots, the packet transmitter opens the first output gate to transmit the high-priority packets from the high-priority packet buffer and closes the second output gate to suppress transmission of the low-priority packets from the low- priority packet buffer.

3. The packet processing apparatus according to claim 2, wherein:
the packet transmitter further includes a gate control list that defines the packet arrival time slots based on a traffic cycle of the high-priority packets.

4. A packet processing system comprising:
a packet processing apparatus configured to include a counter that counts a quantity of packets that have arrived for each of a plurality of time slots to obtain respective first counter values, and a data sequence generator that reads out, at timings that may be asynchronous to the plurality of time slots, the first counter values to obtain respective second counter values, collects the second counter values read out at the timings and corresponding readout times, and generates a data sequence in which the collected second counter values are arranged in an order corresponding to the timings; and
a server apparatus configured to include a processor that divides the data sequence into a plurality of periods of equal length based on the readout times to obtain a first period and a second period, superimposes, with respect to the first period and the second period, a first data sequence included in the first period and a second data sequence included in the second period, determines, based on the readout times corresponding to the second counter values included in the first data sequence and the second data sequence, a first time range during which one or more of the second counter values included in the first data sequence are equal to or greater than one and a second time range during which one or more of the second counter values included in the second data sequence are equal to or greater than one, identifies a common time range shared between the first time range and the second time range, and estimates time slots corresponding to the common time range as packet arrival time slots in which the packets have arrived.

5. The packet processing system according to claim 4, wherein:
the packet processing apparatus further includes a packet transmitter that includes a high-priority packet buffer that buffers high-priority packets, a low-priority packet buffer that buffers low-priority packets, a first output gate that opens and closes an output of the high-priority packet buffer, and a second output gate that opens and closes an output of the low-priority packet buffer, and
during the packet arrival time slots, the packet transmitter opens the first output gate to transmit the high-priority packets from the high-priority packet buffer and closes the second output gate to suppress transmission of the low-priority packets from the low-priority packet buffer.

6. The packet processing system according to claim 5, wherein:
the packet transmitter further includes a gate control list that defines the packet arrival time slots based on a traffic cycle of the high-priority packets.

7. A packet processing method comprising:
reading out, by a processor included in a packet processing apparatus, from a counter that counts a quantity of packets that have arrived for each of a plurality of time slots to obtain respective first counter values, the first counter values to obtain respective second counter values at timings that may be asynchronous to the plurality of time slots, collecting the second counter values read out at the timings and corresponding readout times, and generating a data sequence in which the collected second counter values are arranged in an order corresponding to the timings,
dividing, by the processor, the data sequence into a plurality of periods of equal length based on the readout times to obtain a first period and a second period, and superimposing, with respect to the first period and the second period, a first data sequence included in the first period and a second data sequence included in the second period, and
determining, by the processor, based on the readout times corresponding to the second counter values included in the first data sequence and the second data sequence, a first time range during which one or more of the second counter values included in the first data sequence are equal to or greater than one and a second time range during which one or more of the second counter values included in the second data sequence are equal to or greater than one, identifying a common time range shared between the first time range and the second time range, and estimating time slots corresponding to the common time range as packet arrival time slots in which the packets have arrived.

8. The packet processing method according to claim 7, wherein:
during the packet arrival time slots, a packet transmitter included in the packet processing apparatus opens a first output gate that opens and closes an output of a high-priority packet buffer for buffering high-priority packets so as to transmit the high-priority packets from the high-priority packet buffer, and closes a second output gate that opens and closes an output of a low-priority packet buffer for buffering low-priority packets so as to suppress transmission of the low-priority packets from the low-priority packet buffer.
